(19) United States
(12) Patent Application Publication
(10) Pub. No.: US 2017/0159239 A1
(43) Pub. Date: Jun. 8, 2017

(54) PAPERMAKING SCREEN DEVICE

(71) Applicant: AIKAWA IRON WORKS CO., LTD., Shizuoka-shi (JP)

(72) Inventor: Masaki AIKAWA, Shizuoka-shi (JP)

(21) Appl. No.: 15/255,845

(22) Filed: Sep. 2, 2016

(30) Foreign Application Priority Data
Dec. 2, 2015 (JP) 2015-235281

(51) Int. Cl. D21D 5/16; B02C 23/16; B02C 23/18; D21D 5/02

(52) U.S. Cl. CPC D21D 5/16; D21D 5/02; B02C 23/16; B02C 23/18; B02C 2023/165

(57) ABSTRACT

A papermaking screen device finely selects disintegrated fibers effectively to enhance a fine selection effect, and is made compact. In the papermaking screen device, fibers in an area of a papermaking raw material having a high concentration on a downstream side of a screen are disintegrated by cooperation between stirring-member one-side disintegration portions and screen other-side disintegration portions, and the disintegrated fibers are guided to an outside from a portion inside the cylindrical screen facing end-portion-side stirring members to be finely selected so as to improve the fine selection effect. Also, the papermaking screen device includes disintegration functions inside the screen so as to effectively use a height in a vertical direction of the screen, and make a whole device compact as well.

### BACKGROUND OF THE INVENTION AND RELATED ART STATEMENT

The present invention relates to a papermaking screen device, and especially, relates to the papermaking screen device finely selecting a disintegrated fiber effectively to enhance a fine selection effect and made compact.

Conventionally, there is a papermaking-raw-material screen device comprising a disintegration function (for example, a papermaking-raw-material screen device disclosed in Japanese Unexamined Patent Application Publication No. 2014-55377).

The papermaking-raw-material screen device is provided with a vane on an outer periphery of a rotor, and carries out a mesh cleaning operation of a screen cylinder using a pressure change when the vane passes around the screen cylinder to continuously carry out a fine selection operation of the papermaking raw material.

However, a papermaking raw material having a high concentration on a downstream side of the screen cylinder of the aforementioned papermaking-raw-material screen device is disintegrated at a disintegration portion, and the disintegrated fiber is returned to an upstream side of the screen cylinder, so that for a portion which has been returned, an inflow amount of the papermaking raw material from a raw-material entrance is reduced, and the disintegration portion is positioned in a portion different from the screen cylinder carrying out the fine selection operation, so that if a height in a vertical direction of the screen cylinder is increased, a height in a vertical direction of the device becomes higher so as to have a problem that a whole device becomes large.

The present invention is made in view of the aforementioned current condition, and an object of the present invention is to provide a papermaking screen device.

Further objects and advantages of the invention will be apparent from the following description of the invention.

### SUMMARY OF THE INVENTION

A papermaking screen device according to the first aspect for separating a foreign material from a papermaking raw material through a cylindrical screen inside a casing comprises a first chamber and a second chamber wherein the casing is divided by the cylindrical screen; a papermaking-raw-material supply passage wherein an opening end faces the first chamber to supply the papermaking raw material to the first chamber; a finely-selected-papermaking-raw-material discharge passage wherein an opening end faces the second chamber to discharge the finely selected papermaking raw material in the second chamber to an outside of the casing by the screen; a foreign-material discharge passage wherein an opening end faces the first chamber to discharge a papermaking raw material including a foreign material which cannot pass through the screen in the first chamber to the outside of the casing; a rotor having an approximately columnar shape, disposed inside the screen, and providing a stirring member stirring the papermaking raw material on an outside surface facing the screen; an end-portion-side stirring member attached to a top face of the rotor having the approximately columnar shape, and positioned to face an inside of the cylindrical screen to stir the papermaking raw material; a stirring-member one-side disintegration portion provided on an outer periphery facing the inside of the cylindrical screen of the end-portion-side stirring member; and a screen other-side disintegration portion provided in a portion facing the stirring-member one-side disintegration portion (a stirring-member-side concave-convex-shaped portion), and the screen other-side disintegration portion and the stirring-member one-side disintegration portion work together to disintegrate the papermaking raw material.

Also, as for the papermaking screen device according to a second aspect, in the papermaking screen device according to the first aspect, a portion disintegrating the papermaking raw material by cooperation between the screen other-side disintegration portion and the stirring-member one-side disintegration portion is a disintegration zone portion, and the first chamber is divided into a zone having a low papermaking raw material concentration on a side near the papermaking-raw-material supply passage, and a zone having a high papermaking raw material concentration on a side far from the papermaking-raw-material supply passage through the disintegration zone portion. Also, there is formed a return passage returning the papermaking raw material in the zone having the high papermaking raw material concentration to the zone having the low papermaking raw material concentration on the rotor.

Also, as for the papermaking screen device according to a third aspect, in the papermaking screen device according to the first aspect, a top-portion dilution-water supply passage, wherein a dilution-water opening portion faces (an approximately center portion of) a top portion of the rotor, is attached to the casing, or a side-portion dilution-water supply passage wherein the dilution-water opening portion faces the stirring-member one-side disintegration portion is attached to the casing.

Also, as for the papermaking screen device according to a fourth aspect, in the papermaking screen device according to the first aspect, there are provided the top-portion dilution-water supply passage attached to a top plate of the casing such that the dilution-water opening portion faces an approximately center of the rotor; and the foreign-material discharge passage wherein a foreign-material discharge opening portion faces the top portion of the rotor, attached to a portion separated from the top-portion dilution-water supply passage of the top plate of the casing.

Also, as for the papermaking screen device according to a fifth aspect, in the papermaking screen device according to the first aspect, the end-portion-side stirring member is an end-portion-side longitudinal stirring member having a length in a vertical direction longer than a width in a circumferential direction of the screen, and the stirring-member one-side disintegration portion is a longitudinal-stirring-member one-side disintegration portion, and in a portion facing the longitudinal-stirring-member one-side disintegration portion, there is provided the screen other-side disintegration portion.

According to the papermaking screen device with respect to the first aspect, the papermaking raw material having a low concentration on an upstream side of the screen is disintegrated by the stirring member provided on the outside surface of the rotor having the approximately columnar shape, and disintegrated fibers are guided to an outside from a portion inside the cylindrical screen facing the stirring member to be finely selected. Also, the papermaking raw material having a high concentration on a downstream side of the screen is disintegrated by cooperation between the stirring-member one-side disintegration portion and the screen other-side disintegration portion, and disintegrated fibers are guided to the outside from the portion inside the cylindrical screen facing the end-portion-side stirring member to be finely selected so as to improve a fine selection effect. Furthermore, there is included a disintegration function inside the screen so as to have effects such that a height in a vertical direction of the screen can be effectively used, a whole device can be made compact as well, and the like.

Also, according to the papermaking screen device with respect to the second aspect, in addition to an effect of the invention according to the aforementioned first aspect, in the rotor, there is formed the return passage returning the papermaking raw material in the first chamber wherein the end-portion-side stirring member is positioned to the upstream side above the disintegration zone portion disintegrating the papermaking raw material by cooperation between the screen other-side disintegration portion and the stirring-member one-side disintegration portion; and in the rotor, there is formed the return passage returning the papermaking raw material in the zone having the high papermaking raw material concentration to the zone having the low papermaking raw material concentration so as to prolong a time when the papermaking raw material remains inside the screen, disintegrate not-yet-disintegrated fibers of the papermaking raw material further, and improve the fine selection effect.

Also, according to the papermaking screen device with respect to the third aspect, in addition to the effect of the invention according to the aforementioned first aspect, the top-portion dilution-water supply passage wherein the dilution-water opening portion faces the top portion of the rotor is attached to the casing, so that dilution water from the top-portion dilution-water supply passage diffuses from the top portion of the rotor so as to efficiently dilute the papermaking raw material concentration, and improve a fine selection efficiency of the screen.

Also, according to the papermaking screen device with respect to the fourth aspect, in addition to the effect of the invention according to the aforementioned first aspect, the top-portion dilution-water supply passage wherein the dilution-water opening portion faces the approximately center portion of the top portion of the rotor is attached to the casing, so that the dilution water from the top-portion dilution-water supply passage diffuses from the approximately center portion of the top portion of the rotor so as to efficiently dilute the papermaking raw material concentration, and improve the fine selection efficiency of the screen. Furthermore, there is provided the foreign-material discharge passage wherein the foreign-material discharge opening portion faces the top portion of the rotor, attached to the portion separated from the top-portion dilution-water supply passage of the top plate of the casing, so that the foreign material of the papermaking raw material can be easily taken out of the first chamber, and effective fibers can be easily separated from the papermaking raw material.

Also, according to the papermaking screen device with respect to the fifth aspect, in addition to the effect of the invention according to the aforementioned first aspect, the end-portion-side stirring member is the end-portion-side longitudinal stirring member having the length in the vertical direction longer than the width of the circumferential direction of the screen, so that a processing chamber of the papermaking raw material having the high concentration on the downstream side of the screen can be increased in a vertical direction, and for a portion which has been increased, more papermaking raw materials can be finely selected so as to enhance the fine selection effect further.

### BRIEF DESCRIPTION OF THE DRAWINGS

FIG. 1 is a schematic partial cross-sectional view of a papermaking screen device of one embodiment of the present invention.

FIG. 2 is a schematic perspective view of a rotor of the papermaking screen device in FIG. 1.

FIG. 3 is a schematic perspective view of a screen of the papermaking screen device in FIG. 1.

FIG. 4 is a schematic perspective view of a rotor of another embodiment different from the rotor in FIG. 2.

FIG. 5 is a schematic front view in FIG. 4.

FIG. 6 is a schematic partial cross-sectional view of a papermaking screen device of another embodiment different from the papermaking screen device in FIG. 1.

FIG. 7 is a schematic partial cross-sectional view of a papermaking screen device of another embodiment different from the papermaking screen device in FIG. 6.

### DETAILED DESCRIPTION OF PREFERRED EMBODIMENTS

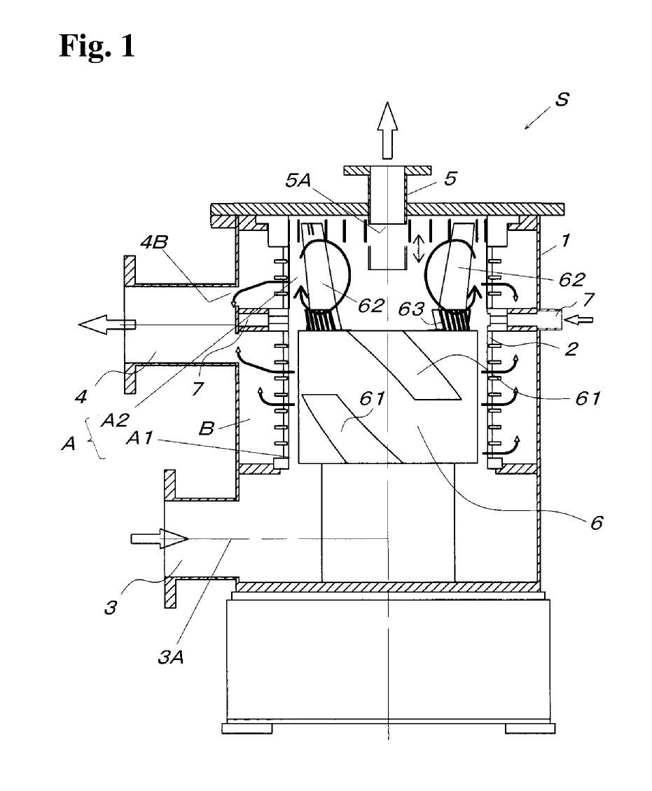

A papermaking screen device of one embodiment of the present invention will be explained with reference to FIG. 1 to FIG. 3.

In FIG. 1, the reference sign S represents a papermaking screen device, and the papermaking screen device S is the device separating a foreign material from a papermaking raw material through a cylindrical screen 2 inside a casing 1 to finely select the papermaking raw material.

The casing 1 is divided into a first chamber A and a second chamber B by the cylindrical screen 2.

In the casing 1, there is connected a papermaking-raw-material supply passage 3. In the papermaking-raw-material supply passage 3, an opening end 3A faces the first chamber A, and the papermaking-raw-material supply passage 3 supplies the papermaking raw material to the first chamber A.

Also, in the casing 1, there is connected a finely-selected-papermaking-raw-material discharge passage 4. In the finely-selected-papermaking-raw-material discharge passage 4, an opening end 4B faces the second chamber B, and the finely-selected-papermaking-raw-material discharge passage 4 discharges a finely selected papermaking raw material in the second chamber B to an outside of the casing 1 through the screen 2.

Also, in the casing 1, there is connected a foreign-material discharge passage 5. In the foreign-material discharge passage 5, an opening end 5A faces the first chamber A, and the foreign-material discharge passage 5 discharges a papermaking raw material including the foreign material which cannot pass through the screen 2 of the first chamber A, to the outside of the casing 1.

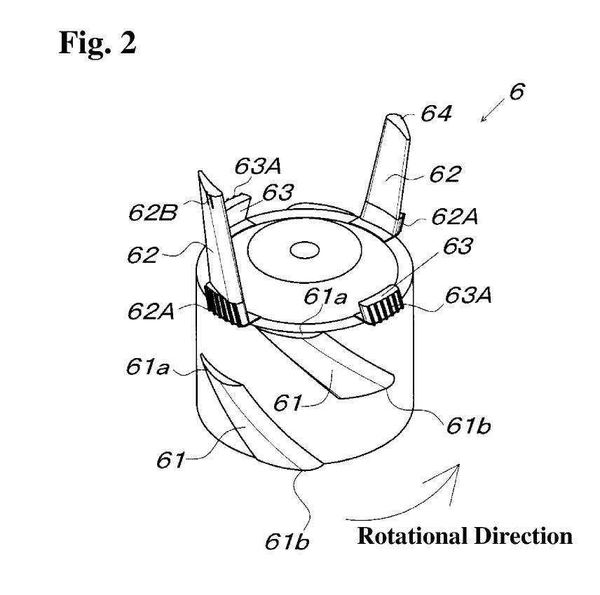

Also, the reference numeral 6 shown in FIG. 1 and FIG. 2 represents a rotor having an approximately columnar shape, and as shown in FIG. 1, the rotor 6 is disposed inside the screen 2, and includes stirring members 61 stirring the papermaking raw material on an outside surface facing the screen 2. The stirring members 61 stir the papermaking raw material, and operate to send the papermaking raw material from an upstream side to a downstream side. There is provided a plurality of stirring members 61, and more specifically, as shown in FIG. 2, upper ends 61a of the stirring members 61 incline in such a way as to be located behind lower ends 61b of the stirring members 61 with respect to a rotation direction (for example, in the rotor 6 in FIG. 2, a counter-clockwise rotation).

Also, the reference numerals 62 and 63 shown in FIG. 1 and FIG. 2 represent end-portion-side stirring members, and the end-portion-side stirring members 62 and 63 are attached to a top face of the rotor 6, and positioned to face an inside of the cylindrical screen 2.

On outer peripheries of the end-portion-side stirring members 62 and 63 facing the inside of the cylindrical screen 2, there are provided stirring-member one-side disintegration portions 62A, 62B, and 63A.

As shown in FIG. 2, the stirring-member one-side disintegration portions 62A, 62B, and 63A may have a concave-convex shape, and may have a concave shape or a convex shape which are not shown in the drawings.

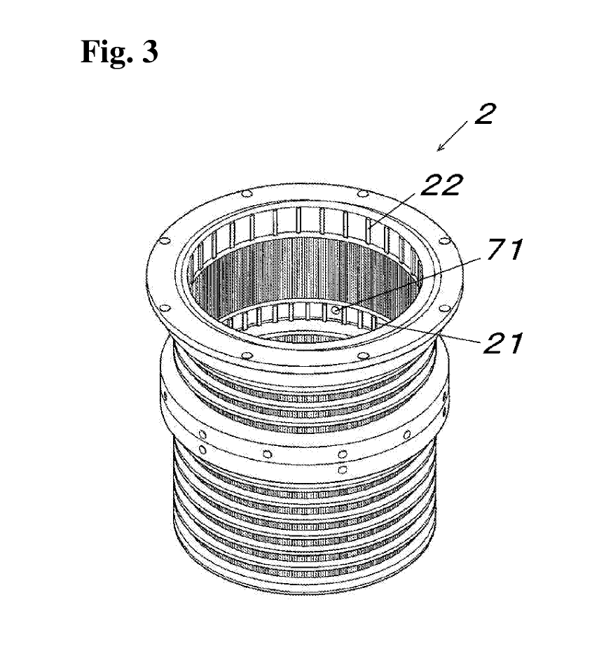

Also, the reference numerals 21 and 22 shown in FIG. 3 represent screen other-side disintegration portions, and the screen other-side disintegration portions 21 and 22 are provided in portions facing the stirring-member one-side disintegration portions 62A, 62B, and 63A, and the stirring-member one-side disintegration portions 62A and 63A face the screen other-side disintegration portion 21, and the stirring-member one-side disintegration portions 62B face the screen other-side disintegration portion 22, respectively. As shown in FIG. 2, the screen other-side disintegration portions 21 and may have a concave-convex shape, and may have a concave shape or a convex shape which are not shown in the drawings.

Incidentally, as shown by arrows in FIG. 1, the end-portion-side stirring members 62 and 62 stir the papermaking raw material, and operate to send the papermaking raw material from the downstream side to the upstream side in an area of the papermaking raw material having a high concentration on the downstream side of the screen 2.

Then, the screen other-side disintegration portions 21 and 22, and the stirring-member one-side disintegration portions 62A, 62B, and 63A work together to disintegrate the papermaking raw material.

Also, the reference numeral 7 shown in FIG. 1 represents a side-portion dilution-water supply passage, and the side-portion dilution-water supply passage 7 is attached to the casing 1 such that a dilution-water opening portion 71 (see FIG. 3) faces the stirring-member one-side disintegration portions 62A and 63A. Then, dilution water from the side-portion dilution-water supply passage 7 efficiently dilutes the papermaking raw material in proximity to the stirring-member one-side disintegration portions 62A and 63A to allow the papermaking raw material to be easily disintegrated so as to improve a fine selection efficiency of the screen.

Therefore, when the papermaking raw material is supplied to the inside of the screen 2, i.e. the first chamber A through the papermaking-raw-material supply passage 3, and stirred by the stirring members 61 of the rotor 6, fibers inside the papermaking raw material pass through the screen 2, and the foreign material inside the papermaking raw material cannot pass through the screen 2, so that the papermaking raw material is finely selected.

Namely, the papermaking raw material having a low concentration on the upstream side of the screen 2 is stirred by the stirring members 61 provided on the outside surface of the rotor 6 having the approximately columnar shape, and the stirred fiber is guided to an outside from a portion inside the cylindrical screen 2 facing the stirring members 61 to be finely selected.

Then, at a front portion of the stirring members 61, there is applied a pressure relative to the screen 2, and at a back portion of the stirring members 61, there is applied a negative pressure relative to the screen 2 so as to provide a mesh cleaning operation of the screen 2 to prevent clogging of the meshes of the screen 2.

Also, the papermaking raw material having the high concentration on the downstream side of the screen 2 is disintegrated by cooperation between the stirring-member one-side disintegration portions 62A, 62B, and 63A, and the screen other-side disintegration portions 21 and 22, and the disintegrated fiber is guided to the outside from the portion inside the cylindrical screen 2 facing the end-portion-side stirring members 62 and 63 to be finely selected so as to improve a fine selection effect. Also, there are included disintegration functions (62A, 62B, 63A, 21, and 22) inside the screen 2 so as to have effects such that a height in a vertical direction of the screen 2 can be effectively used, and a whole device can be made compact as well, and the like.

Incidentally, as shown in FIG. 1 and FIG. 2, the end-portion-side stirring members 62 are end-portion-side longitudinal stirring members 62 wherein a length in a vertical direction is longer than a width in a circumferential direction of the screen 2, so that a processing chamber of the papermaking raw material having the high concentration on the downstream side of the screen 2 can be increased in a vertical direction, and for a portion which has been increased, more papermaking raw materials can be finely selected so as to enhance the fine selection effect further.

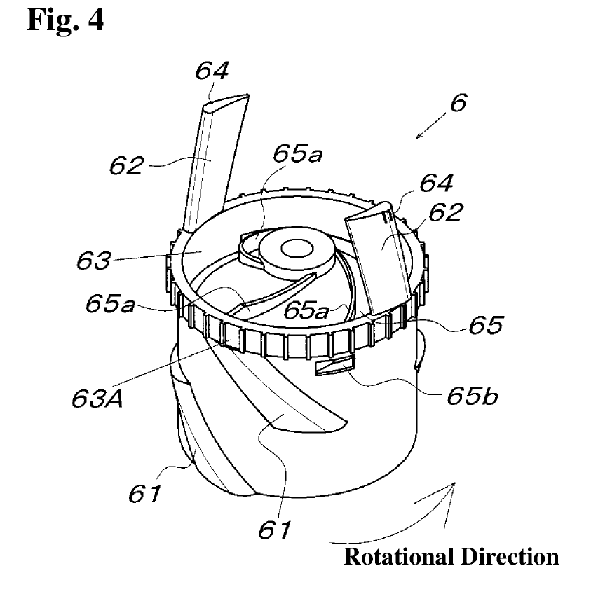

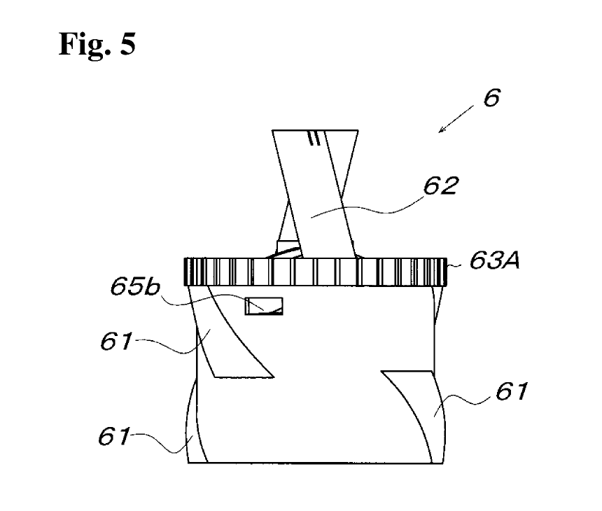

Also, FIG. 4 and FIG. 5 are other embodiments of the rotor 6 in FIG. 2; the reference numeral 65 shown in FIG. 4 represents a return passage formed in the rotor 6; and the stirring-member one-side disintegration portion 63A is provided along a whole periphery of the rotor 6, and has a positional relationship of facing the screen other-side disintegration portion 21.

Then, a portion disintegrating the papermaking raw material by cooperation between the screen other-side disintegration portion 21 and the stirring-member one-side disintegration portion 63A is a disintegration zone portion, and the first chamber A is divided into a zone (A1 in FIG. 1) having a low papermaking raw material concentration on a side near the papermaking-raw-material supply passage 3, and a zone (A2 in FIG. 1) having a high papermaking raw material concentration on a side far from the papermaking-raw-material supply passage 3 through the aforementioned disintegration zone portion. Also, the return passage 65 returns the papermaking raw material in the zone A2 having the high papermaking raw material concentration to the zone A1 having the low papermaking raw material concentration.

The reference sign 65a shown in FIG. 4 represents guide vanes provided on a top portion of the rotor 6, and the reference sign 65b shown in FIG. 4 and FIG. 5 represents an opening portion returning the papermaking raw material guided to the guide vanes 65a to the upstream side above the disintegration zone portion.

Namely, there is formed the return passage 65 returning the papermaking raw material in the zone A2 having the high papermaking raw material concentration to the zone A1 having the low papermaking raw material concentration in the rotor 6 so as to prolong a time when the papermaking raw material remains inside the screen 2, disintegrate not-yet-disintegrated fibers of the papermaking raw material further, and improve the fine selection effect.

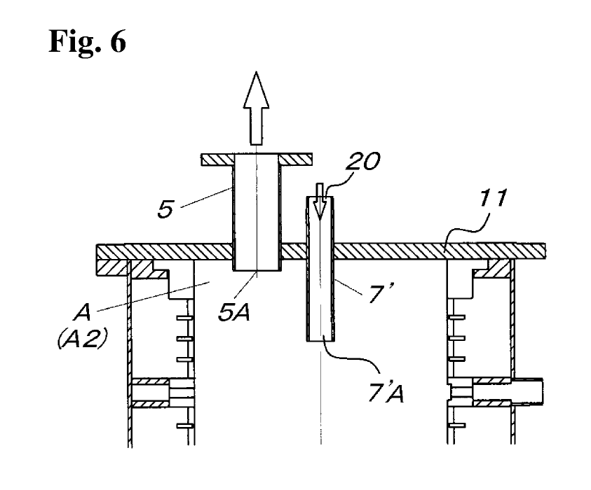

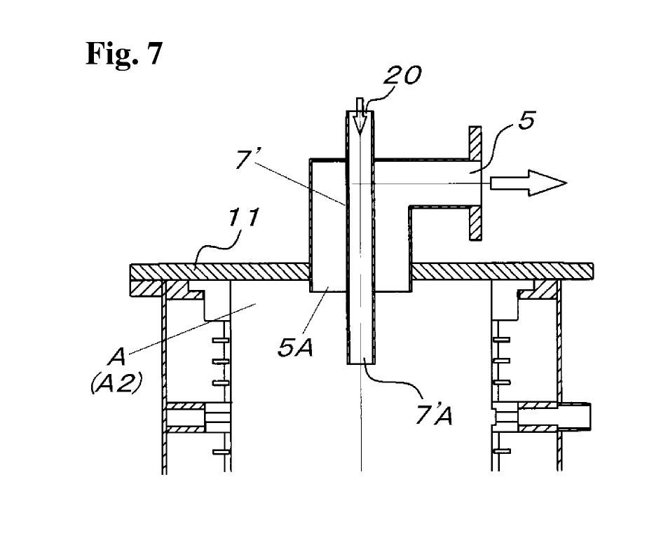

Incidentally, the dilution-water opening portion 71 (see FIG. 3) of the side-portion dilution-water supply passage 7 is provided in such a way as to face the stirring-member one-side disintegration portions 62A and 63A; however, in the present invention, it is not limited to the above, and for example, it may be provided in such a manner shown in FIG. 6 and FIG. 7.

Namely, the reference sign 7′ shown in FIG. 6 and FIG. 7 is a top-portion dilution-water supply passage, and the top-portion dilution-water supply passage 7′ is attached to a top plate 11 of the casing 1 such that a dilution-water opening portion 7′A faces the top portion of the rotor 6 (for example, an approximately center portion of the top portion of the rotor 6). Dilution water 20 from the top-portion dilution-water supply passage 7′ diffuses from the top portion of the rotor 6 (for example, the approximately center portion of the top portion of the rotor 6) so as to efficiently dilute a papermaking raw material concentration, and improve the fine selection efficiency of the screen.

Also, in a case wherein the foreign-material discharge passage 5 and the top-portion dilution-water supply passage 7′ are attached to the top plate 11 of the casing 1, the opening end 5A of the foreign-material discharge passage 5 is preferred to be set at a higher position in a vertical direction than the dilution-water opening portion 7′A of the top-portion dilution-water supply passage 7′.

This allows a foreign material which has floated up to be easily discharged through the opening end 5A of the foreign-material discharge passage 5, and efficiently supplies the dilution water 20 from the dilution-water opening portion 7′A of the top-portion dilution-water supply passage 7′ to the papermaking raw material having the high concentration.

Also, as shown in FIG. 6, a center of the foreign-material discharge passage 5 and a center of the top-portion dilution-water supply passage 7′ may be set to be shifted from each other. Also, as shown in FIG. 7, the center of the foreign-material discharge passage 5 and the center of the top-portion dilution-water supply passage 7′ may be set to be matched.

Also, when the top-portion dilution-water supply passage 7′, wherein the dilution-water opening portion 7′A faces the approximately center portion of the top portion of the rotor 6, is attached to the casing 1, the dilution water from the top-portion dilution-water supply passage 7′ diffuses from the approximately center portion of the top portion of the rotor 6 so as to efficiently dilute the papermaking raw material concentration, and improve the fine selection efficiency of the screen. Also, there is provided the foreign-material discharge passage 5 (see FIG. 6) wherein the foreign-material discharge opening end 5A faces the top portion of the rotor 6, attached to a portion separated from the top-portion dilution-water supply passage 7′ of the top plate 11 of the casing 1, so that the foreign material of the papermaking raw material can be easily taken out of the first chamber A (A2), and an effective fiber can be easily separated from the papermaking raw material.

Also, for example, the position of the opening end 5A of the foreign-material discharge passage 5 may be lifted up or lowered down by a lifting and lowering device (not shown in the drawings) in such a way as to move the foreign-material discharge passage 5 up and down in the vertical direction.

This is for lifting the position of the opening end 5A of the foreign-material discharge passage 5 in a case wherein the foreign material is desired to be taken out according to an amount of the foreign material in the first chamber A (A2), i.e. more, and lowering the position of the opening end 5A of the foreign-material discharge passage 5 in a case wherein the foreign material is not desired to be taken out more.

The disclosure of Japanese Patent Application No. 2015-235281, filed on Dec. 2, 2015, is incorporated in the application.

While the invention has been explained with reference to the specific embodiments of the invention, the explanation is illustrative and the invention is limited only by the appended claims.

What is claimed is:

1. A papermaking screen device for separating a foreign material from a papermaking raw material, comprising:
a casing;
a cylindrical screen inside the casing;
a first chamber and a second chamber divided by the cylindrical screen inside the casing;
a papermaking-raw-material supply passage having a supply opening end facing the first chamber to supply the papermaking raw material to the first chamber;
a finely-selected-papermaking-raw-material discharge passage having a discharge opening end facing the second chamber to discharge a finely selected papermaking raw material by the screen, in the second chamber to an outside of the casing;
a foreign-material discharge passage having another discharge opening end facing the first chamber to discharge a papermaking raw material including a foreign material which cannot pass through the screen in the first chamber to the outside of the casing;
a rotor having an approximately columnar shape, disposed inside the screen, and including a stirring member stirring the papermaking raw material on an outside surface thereof, facing the screen;
an end-portion-side stirring member attached to a top face of the rotor positioned to face an inside of the cylindrical screen to stir the papermaking raw material;
a stirring-member one-side disintegration portion provided on an outer periphery facing the inside of the cylindrical screen of the end-portion-side stirring member; and
a screen other-side disintegration portion provided in a portion facing the stirring-member one-side disintegration portion,
wherein the screen other-side disintegration portion, and the stirring-member one-side disintegration portion work together to disintegrate the papermaking raw material.

2. A papermaking screen device according to claim 1, wherein a portion disintegrating the papermaking raw material by cooperation between the screen other-side disintegration portion and the stirring-member one-side disintegration portion is a disintegration zone portion inside the screen,
the first chamber is divided into a zone having a low papermaking raw material concentration on a side near the papermaking-raw-material supply passage, and a zone having a high papermaking raw material concentration on a side far from the papermaking-raw-material supply passage through the disintegration zone portion, and
a return passage returning the papermaking raw material in the zone having the high papermaking raw material concentration to the zone having the low papermaking raw material concentration is formed on the rotor.

3. A papermaking screen device according to claim 1, further comprising a dilution-water supply passage wherein a dilution-water opening portion facing a top portion of the rotor is attached to a top portion of the casing, or wherein a dilution-water opening portion facing the stirring-member one-side disintegration portion is attached to a side-portion of the casing.

4. A papermaking screen device according to claim 1, further comprising,
a top-portion dilution-water supply passage attached to a top plate of the casing such that a dilution-water opening portion faces an approximately center of the rotor; and
a foreign-material discharge passage wherein a foreign-material discharge opening portion faces a top portion of the rotor, and attached to a portion separated from the top-portion dilution-water supply passage of the top plate of the casing.

5. A papermaking screen device according to claim 1, wherein the end-portion-side stirring member is an end-portion-side longitudinal stirring member having a length in a vertical direction longer than a width in a circumferential direction of the screen,
the stirring-member one-side disintegration portion is a longitudinal-stirring-member one-side disintegration portion, and
the screen other-side disintegration portion is provided in a portion facing the longitudinal-stirring-member one-side disintegration portion.
